(19) United States
(12) Patent Application Publication
(10) Pub. No.: US 2018/0211616 A1
(43) Pub. Date: Jul. 26, 2018

(54) TIMING DRIVING METHOD, A TIMING DRIVING SYSTEM AND A LIQUID CRYSTAL DISPLAY

(71) Applicant: Wenying LI, Shenzhen, Guangdong (CN)

(72) Inventor: Wenying LI, Shenzhen, Guangdong (CN)

(73) Assignee: Shenzhen China Star Optoelectronics Technology Co., Ltd., Shenzhen, Guangdong (CN)

(21) Appl. No.: 15/327,257

(22) PCT Filed: Dec. 28, 2016
(86) PCT No.: PCT/CN2016/112511

§ 371 Date: Jan. 18, 2017

(30) Foreign Application Priority Data
Sep. 26, 2016 (CN) 201610851141.3

(51) Int. Cl. G09G 3/36

(52) U.S. Cl. CPC G09G 3/3614; G09G 2310/08

(57) ABSTRACT

A timing driving method used for providing a timing signal to a data line of a liquid crystal display, the timing driving method includes determining the image of the liquid crystal display is a static image; determining the reverse mode of the liquid crystal display; and extending the polarity changing time of the timing signal of the data line according to the inversion mode of the liquid crystal display, thus reducing the polarity inversion frequency or the driving frame frequency when display static image, the kind of the driving mode can not only maintain the continuity of displaying dynamic image, but also reducing the power consumption of the data driving device when displaying the static image, thereby reducing the power consumption of the liquid crystal display.

### CROSS REFERENCE

This application claims priority to Chinese Patent Application No. 201610851141.3, entitled “TIMING DRIVING METHOD, A TIMING DRIVING SYSTEM AND A LIQUID CRYSTAL DISPLAY”, filed on Sep. 26, 2016, which is incorporated by reference in its entirety.

### FIELD OF THE INVENTION

The present application relates to a display technology field, and more particularly to a timing driving method, a timing driving system and a liquid crystal display.

### BACKGROUND OF THE INVENTION

Liquid crystal display with its advantages of high display quality, low cost, easy to carry, etc., becomes a display terminal for mobile communication devices and other devices. The liquid crystal display widely used currently, is usually composed by the upper and lower substrate and the middle liquid crystal layer, the substrate is formed by glass and electrodes and other components. With the awareness of green energy-saving, low-carbon environmental protection enjoys popular support, people's requirements for power consumption of device is also increasing, display device is no exception. As mobile devices, such as laptops, handheld computers, and cell phones, rely on battery power for most of the time, and battery capacity is limited, reducing power consumption is particularly important for extending device working time. Now, mobile, handheld devices commonly used TFT-LCD display, there are research data show that, TFT-LCD power consumption accounts for about 40% of the overall power consumption, so TFT-LCD technology and industrial development faces serious challenges to reduce power consumption.

### SUMMARY OF THE INVENTION

The object of the present application is to provide a timing driving method for reducing the power consumption of a liquid crystal display.

The another object of the present application is to provide a timing drive system and a display.

In order to achieve the above-mentioned object, the present application provides the following technical solutions:

The present application provides a timing driving method for providing a timing signal to a data line of a liquid crystal display, the timing driving method including:

determining the image of the liquid crystal display is a static image;

determining the reverse mode of the liquid crystal display; and

extending the polarity changing time of the timing signal of the data line according to the inversion mode of the liquid crystal display.

Wherein when the inversion mode of the liquid crystal display is frame inversion or row inversion is determined, to control the polarity of the timing signal of the data line in the adjacent at least two frames is the same.

Wherein when the inversion mode of the liquid crystal display is frame inversion or row inversion is determined, to control the polarity of the timing signal of the data line in the adjacent three frames is the same.

Wherein when the inversion mode of the liquid crystal display is column inversion or dot inversion is determined, to control the polarity of the timing signal of the data line in the adjacent at least two columns in the same frame is the same.

Wherein when the inversion mode of the liquid crystal display is column inversion or dot inversion is determined, to control the polarity of the timing signal of the data line in the adjacent three columns in the same frame is the same.

The present application provides a timing driving system used to provide timing signals to the data lines of a liquid crystal display, wherein the timing driving system comprising a determination unit and a control unit, the determination unit is configured to determine the image of the liquid crystal display is a static image and to determine the reverse mode of the liquid crystal display, the control unit is configured to extend the polarity changing time of the timing signal of the data line according to the inversion mode of the liquid crystal display.

Wherein the determination unit is further configured to transmit a first control signal to the control unit when determining the inversion mode of the liquid crystal display is frame inversion or row inversion, and the control unit is further configured to control the polarity of the timing signals of the data lines in adjacent at least two frames to be the same in accordance with the first control signal.

Wherein the control unit is further configured to control the polarity of the timing signals of the data lines in adjacent three frames to be the same in accordance with the first control signal.

Wherein the determination unit is further configured to transmit a second control signal to the control unit when determining the inversion mode of the liquid crystal display is column inversion or dot inversion, and the control unit is further configured to control the polarity of the timing signals of the data lines in adjacent at least two columns in the same frame to be the same in accordance with the second control signal.

The present application provides a liquid crystal display including a data line and a timing driving system, the timing driving system is configured to provide a data signal to the line data.

The embodiments of the present application have the following advantages or benefits:

A timing driving method used for providing a timing signal to a data line of a liquid crystal display, the timing driving method includes determining the image of the liquid crystal display is a static image; determining the reverse mode of the liquid crystal display; and extending the polarity changing time of the timing signal of the data line according to the inversion mode of the liquid crystal display, thus reducing the polarity inversion frequency or the driving frame frequency when display static image, the kind of the driving mode can not only maintain the continuity of displaying dynamic image, but also reducing the power consumption of the data driving device when displaying the static image, thereby reducing the power consumption of the liquid crystal display.

### BRIEF DESCRIPTION OF THE DRAWINGS

In order to more clearly illustrate the embodiments of the present application or prior art, the following figures will be described in the embodiments are briefly introduced. It is obvious that the drawings are merely some embodiments of the present application, those of ordinary skill in this field can obtain other figures according to these figures without paying the premise.

FIG. 1 is a flow chart of a timing driving method according to a first aspect of the present application;

FIG. 2 is a signal timing diagram of the data line during a frame inversion or a row inversion in accordance with the timing driving method illustrated in FIG. 1;

FIG. 3 is a signal timing diagram of the data line during a column inversion or a dot inversion in accordance with the timing driving method illustrated in FIG. 1;

FIG. 4 is a block diagram of a timing drive system according to a second aspect of the present application; and

FIG. 5 is a block diagram of a liquid crystal display according to a third aspect of the present application.

### DETAILED DESCRIPTION OF PREFERRED EMBODIMENTS

Embodiments of the present application are described in detail with the technical matters, structural features, achieved objects, and effects with reference to the accompanying drawings as follows. It is clear that the described embodiments are part of embodiments of the present application, but not all embodiments. Based on the embodiments of the present application, all other embodiments to those of ordinary skill in the premise of no creative efforts acquired should be considered within the scope of protection of the present application.

Specifically, the terminologies in the embodiments of the present application are merely for describing the purpose of the certain embodiment, but not to limit the invention. Embodiments and the claims be implemented in the present application requires the use of the singular form of the book “an”, “the” and “the” are intend to include most forms unless the context clearly dictates otherwise. It should also be understood that the terminology used herein that “and/or” means and includes any or all possible combinations of one or more of the associated listed items.

In addition, the following description of the embodiments is given by way of illustration with reference to the specific embodiments in which the invention may be practiced. In the present invention, the terms such as “upper”, “lower”, “front”, “rear”, “left”, “right”, “inner”, “outer”, “side” Is used to refer to the direction of the additional figures, the directional words are used for the purpose of better and more clearly illustrating and understanding the invention and are not intended to imply or imply that the device or element to be referred to must have a particular orientation in a particular orientation construction and operation of the present invention and are therefore not to be construed as limiting the invention.

In the description of the invention, it should be noted that the terms “install”, “connect”, “connect” shall be understood broadly, unless the context clearly dictates otherwise, for example, a fixed connection or a detachable or may be either directly connected or indirectly connected by an intermediate medium, and may be internal to both of the elements. It will be apparent to those skilled in the art that the specific meaning of the above-described terms may be used in the present invention.

In addition, in the description of the present invention, the “plurality” means two or more unless otherwise specified. When the term “process” is used in this specification, it refers not only to an independent process, but also to the term as long as the expected effect of the process can be achieved when it cannot be clearly distinguished from other processes. The numerical range indicated by “˜” In the present specification means a range in which the numerical values before and after “˜” are included as the minimum value and the maximum value, respectively. In the drawings, structures that are similar or identical are denoted by the same reference numerals.

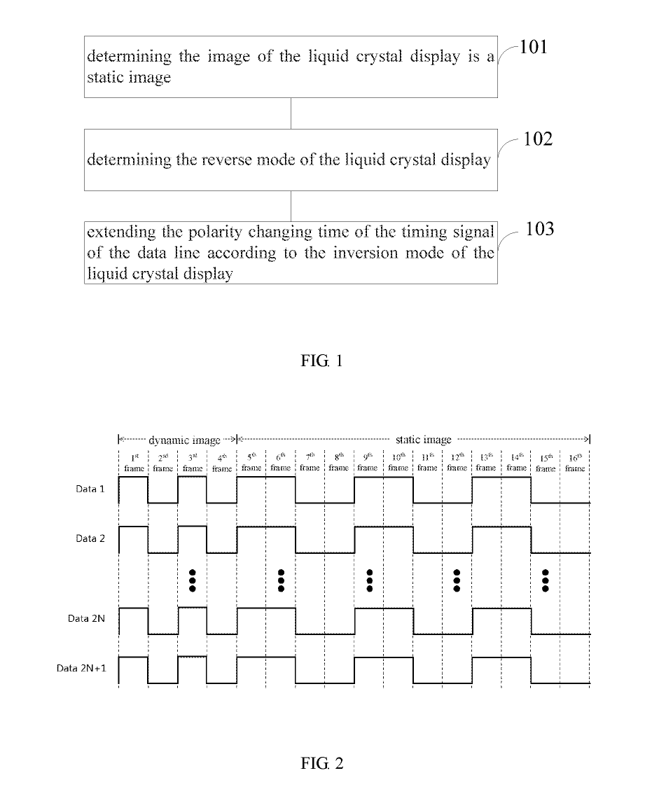

Referring to FIG. 1, the first aspect embodiment of the present application provides a timing driving method. The timing driving method is used for providing a timing signal to a data line of a liquid crystal display. The timing driving method including the steps of:

Step 101, determining the image of the liquid crystal display is a static image.

It should be noted that the image of the liquid crystal display includes a dynamic image and a static image. Since the changes of the polarity inversion frequency or the frame driving frequency of the liquid crystal display is not affecting the effect of the static image. So it is necessary to determine whether the image of the liquid crystal display is a static image or not.

Step 102, determining the reverse mode of the liquid crystal display.

It should be noted that the inversion mode of the liquid crystal display includes column inversion, row inversion, dot inversion and frame inversion.

Step 103, extending the polarity changing time of the timing signal of the data line according to the inversion mode of the liquid crystal display.

Specifically, when it is determined that the inversion mode of the liquid crystal display is frame inversion or row inversion, the manner of extending the polarity changing time of the timing signal of the data line is to control the polarity of the timing signal of the data line in the adjacent at least two frames is the same (referring to FIG. 2).

It should be noted that, in the conventional technology, the polarity of the timing signal of the data line in the adjacent two frames is opposite. In the present embodiment, by controlling the polarity of the timing signal of the data line in the adjacent at least two frames is the same, thus reducing the frame driving frequency when display static image, the kind of the driving mode can not only maintain the continuity of displaying dynamic image, but also reducing the power consumption of the data driving device when displaying the static image, thereby reducing the power consumption of the liquid crystal display.

Specifically, when the inversion mode of the liquid crystal display is determined as the frame inversion or the row inversion, it is possible to control the polarity of the timing signal of the data lines in the adjacent three frames to be the same.

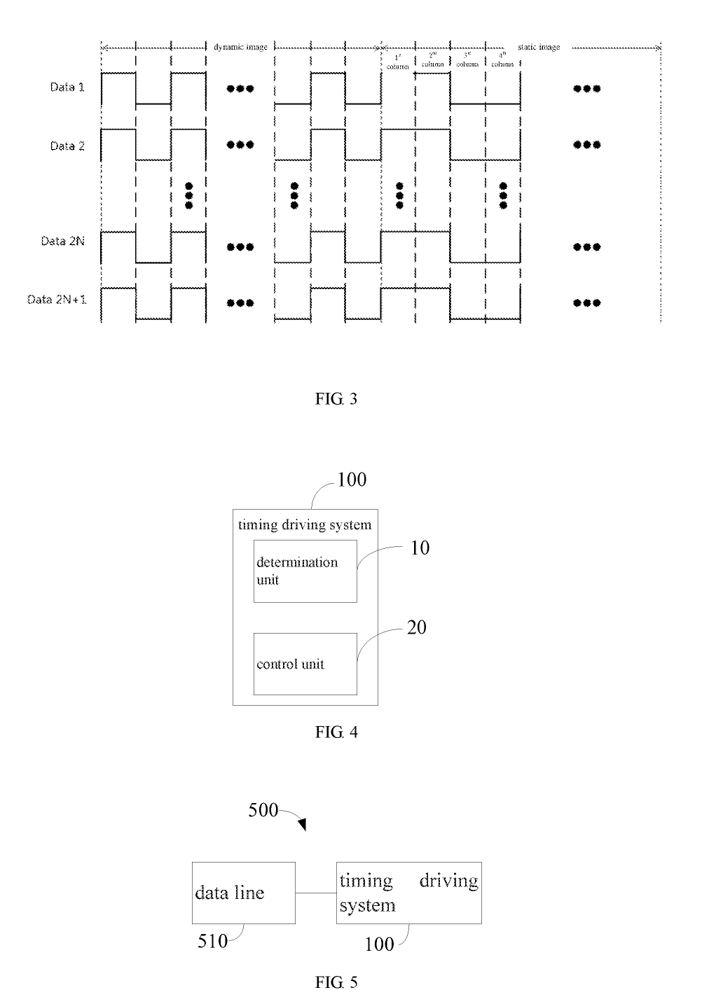

When it is determined that the inversion mode of the liquid crystal display is column inversion or dot inversion, the manner of extending the polarity changing time of the timing signal of the data line is to control the polarity of the timing signal of the data line in the adjacent at least two columns in the same frame is the same (referring to FIG. 3).

It should be noted that, in the conventional technology, the polarity of the timing signal of the data line in the adjacent two columns is opposite. In the present embodiment, by controlling the polarity of the timing signal of the data line in the adjacent at least two columns in the same frame is the same, thus reducing the polarity inversion frequency when display static image, the kind of the driving mode can not only maintain the continuity of displaying dynamic image, but also reducing the power consumption of the data driving device when displaying the static image, thereby reducing the power consumption of the liquid crystal display.

Specifically, when the inversion mode of the liquid crystal display is determined as the column inversion or dot inversion, it is possible to control the polarity of the timing signal of the data lines in the adjacent three columns in the same frame to be the same.

In the present embodiment, the timing driving method includes determining the image of the liquid crystal display is a static image; determining the reverse mode of the liquid crystal display; and extending the polarity changing time of the timing signal of the data line according to the inversion mode of the liquid crystal display, thus reducing the polarity inversion frequency or the frame driving frequency of the liquid crystal display, the kind of the driving mode can not only maintain the continuity of displaying dynamic image, but also reducing the power consumption of the data driving device when displaying the static image, thereby reducing the power consumption of the liquid crystal display.

Referring to FIG. 4, a second aspect of the embodiment of the present application provides a timing driving system 100. The timing driving system 100 is used to provide timing signals to the data lines of the liquid crystal display. The timing driving system 100 includes a determination unit 10 and a control unit 20.

The determination unit 10 is configured to determine the image of the liquid crystal display is a static image and to determine the reverse mode of the liquid crystal display.

It should be noted that the image of the liquid crystal display includes a dynamic image and a static image. Since the changes of the polarity inversion frequency or the frame driving frequency of the liquid crystal display is not affecting the effect of the static image. So it is necessary to determine whether the image of the liquid crystal display is a static image or not. The inversion mode of the liquid crystal display includes column inversion, row inversion, dot inversion and frame inversion.

The control unit 20 is configured to extend the polarity changing time of the timing signal of the data line according to the inversion mode of the liquid crystal display.

Specifically, the determination unit 10 is further configured to transmit a first control signal to the control unit 20 when determining the inversion mode of the liquid crystal display is frame inversion or row inversion, and the control unit 20 is further configured to control the polarity of the timing signals of the data lines in adjacent at least two frames to be the same in accordance with the first control signal.

It should be noted that, in the conventional technology, the polarity of the timing signal of the data line in the adjacent two frames is opposite. In the present embodiment, by controlling the polarity of the timing signal of the data line in the adjacent at least two frames is the same by the control unit 20, thus reducing the frame driving frequency when display static image, the kind of the driving mode can not only maintain the continuity of displaying dynamic image, but also reducing the power consumption of the data driving device when displaying the static image, thereby reducing the power consumption of the liquid crystal display.

Specifically, the control unit 20 is further configured to control the polarity of the timing signals of the data lines in adjacent three frames to be the same in accordance with the first control signal.

The determination unit 10 is further configured to transmit a second control signal to the control unit 20 when determining the inversion mode of the liquid crystal display is column inversion or dot inversion, and the control unit 20 is further configured to control the polarity of the timing signals of the data lines in adjacent at least two columns in the same frame to be the same in accordance with the second control signal.

It should be noted that, in the conventional technology, the polarity of the timing signal of the data line in the adjacent two columns is opposite. In the present embodiment, by controlling the polarity of the timing signal of the data line in the adjacent at least two columns in the same frame is the same by the control unit 20, thus reducing the polarity inversion frequency when display static image, the kind of the driving mode can not only maintain the continuity of displaying dynamic image, but also reducing the power consumption of the data driving device when displaying the static image, thereby reducing the power consumption of the liquid crystal display.

Specifically, the control unit 20 is further configured to control the polarity of the timing signals of the data lines in adjacent three columns in the same frame to be the same in accordance with the second control signal.

In the present embodiment, the timing driving system 100 includes the determination unit 10 and the control unit 20, the determination unit 10 is configured to determine the image of the liquid crystal display is a static image and determine the reverse mode of the liquid crystal display. The control unit 20 is configured to extend the polarity changing time of the timing signal of the data line according to the inversion mode of the liquid crystal display, thus reducing the polarity inversion frequency or the frame driving frequency of the liquid crystal display, the kind of the driving mode can not only maintain the continuity of displaying dynamic image, but also reducing the power consumption of the data driving device when displaying the static image, thereby reducing the power consumption of the liquid crystal display.

Referring to FIG. 5, a third aspect of the present application provides a liquid crystal display 500. The liquid crystal display 500 includes a data line 510 and a timing driving system. The timing driving system is configured to provide a data signal to the line data 510. The timing driving system is the timing driving system 100 provided in the second aspect. Since the timing driving system 100 is described in detail in the above-described second aspect, it will not be described again.

In the present embodiment, the liquid crystal display 500 includes the timing driving system 100. The timing driving system 100 includes the determination unit 10 and the control unit 20, the determination unit 10 is configured to determine the image of the liquid crystal display is a static image and determine the reverse mode of the liquid crystal display. The control unit 20 is configured to extend the polarity changing time of the timing signal of the data line according to the inversion mode of the liquid crystal display, thus reducing the polarity inversion frequency or the frame driving frequency of the liquid crystal display, the kind of the driving mode can not only maintain the continuity of displaying dynamic image, but also reducing the power consumption of the data driving device when displaying the static image, thereby reducing the power consumption of the liquid crystal display 500.

In the description of the specification, reference to the terms “one embodiment”, “some embodiments”, “examples”, “specific examples”, “some examples” and the like is meant to refer to a particular feature described in connection with the embodiment or example, Structures, materials, or characteristics are included in at least one embodiment or example of the present invention. In the present specification, a schematic representation of the above terms does not necessarily refer to the same embodiment or example. Moreover, the particular features, structures, materials, or characteristics described may be combined in any one or more embodiments or examples in a suitable manner.

Above are embodiments of the present application, which does not limit the scope of the present application. Any modifications, equivalent replacements or improvements within the spirit and principles of the embodiment described above should be covered by the protected scope of the invention.

1. A timing driving method used for providing a timing signal to a data line of a liquid crystal display, wherein the timing driving method comprising:
determining the image of the liquid crystal display is a static image;
determining the reverse mode of the liquid crystal display; and
extending the polarity changing time of the timing signal of the data line according to the inversion mode of the liquid crystal display.

2. The timing driving method according to claim 1, wherein when the inversion mode of the liquid crystal display is frame inversion or row inversion is determined, to control the polarity of the timing signal of the data line in the adjacent at least two frames is the same.

3. The timing driving method according to claim 2, wherein when the inversion mode of the liquid crystal display is frame inversion or row inversion is determined, to control the polarity of the timing signal of the data line in the adjacent three frames is the same.

4. The timing driving method according to claim 1, wherein when the inversion mode of the liquid crystal display is column inversion or dot inversion is determined, to control the polarity of the timing signal of the data line in the adjacent at least two columns in the same frame is the same.

5. The timing driving method according to claim 4, wherein when the inversion mode of the liquid crystal display is column inversion or dot inversion is determined, to control the polarity of the timing signal of the data line in the adjacent three columns in the same frame is the same.

6. A timing driving system used to provide timing signals to the data lines of a liquid crystal display, wherein the timing driving system comprising a determination unit and a control unit, the determination unit is configured to determine the image of the liquid crystal display is a static image and to determine the reverse mode of the liquid crystal display, the control unit is configured to extend the polarity changing time of the timing signal of the data line according to the inversion mode of the liquid crystal display.

7. The timing driving system according to claim 6, wherein the determination unit is further configured to transmit a first control signal to the control unit when determining the inversion mode of the liquid crystal display is frame inversion or row inversion, and the control unit is further configured to control the polarity of the timing signals of the data lines in adjacent at least two frames to be the same in accordance with the first control signal.

8. The timing driving system according to claim 6, wherein the control unit is further configured to control the polarity of the timing signals of the data lines in adjacent three frames to be the same in accordance with the first control signal.

9. The timing driving system according to claim 6, wherein the determination unit is further configured to transmit a second control signal to the control unit when determining the inversion mode of the liquid crystal display is column inversion or dot inversion, and the control unit is further configured to control the polarity of the timing signals of the data lines in adjacent at least two columns in the same frame to be the same in accordance with the second control signal.

10. A liquid crystal display comprising a data line and a timing driving system, the timing driving system is configured to provide a data signal to the line data, the timing driving system comprising a determination unit and a control unit, the determination unit is configured to determine the image of the liquid crystal display is a static image and to determine the reverse mode of the liquid crystal display, the control unit is configured to extend the polarity changing time of the timing signal of the data line according to the inversion mode of the liquid crystal display.

11. The liquid crystal display according to claim 10, wherein the determination unit is further configured to transmit a first control signal to the control unit when determining the inversion mode of the liquid crystal display is frame inversion or row inversion, and the control unit is further configured to control the polarity of the timing signals of the data lines in adjacent at least two frames to be the same in accordance with the first control signal.

12. The liquid crystal display according to claim 10, wherein the control unit is further configured to control the polarity of the timing signals of the data lines in adjacent three frames to be the same in accordance with the first control signal.

13. The liquid crystal display according to claim 10, wherein the determination unit is further configured to transmit a second control signal to the control unit when determining the inversion mode of the liquid crystal display is column inversion or dot inversion, and the control unit is further configured to control the polarity of the timing signals of the data lines in adjacent at least two columns in the same frame to be the same in accordance with the second control signal.
